(19) United States
(12) Patent Application Publication
(10) Pub. No.: US 2013/0140737 A1
(43) Pub. Date: Jun. 6, 2013

(54) STACKED SUBSTRATE MOLDING

(71) Applicant: Lim Jin Keong, Kuala Lumpur (MY)

(72) Inventor: Lim Jin Keong, Kuala Lumpur (MY)

(73) Assignee: TEXAS INSTRUMENTS INCORPORATED, Dallas, TX (US)

(21) Appl. No.: 13/312,671

(22) Filed: Dec. 6, 2011

(51) Int. Cl. B29C 45/14

(52) U.S. Cl. 264/272.15; 425/116

(57) ABSTRACT

A transfer mold assembly including a first mold chase; a second mold chase; a first lead frame; at least one first lead frame die mounted on the first lead frame; a second lead frame substantially identical to the first lead frame; at least one second lead frame die mounted on the second lead frame; and wherein the first and second mold chases define a transfer mold cavity and wherein the first and second lead frames are positioned in stacked relationship inside the transfer mold cavity. Also disclosed is a method of integrated circuit packaging.

### BACKGROUND

In producing integrated circuits, it is often desirable to provide packaged integrated circuits having plastic or resin packages that encapsulate the die and a portion of the lead frame and leads. These packages have been produced a variety of ways.

Conventional molding techniques take advantage of the physical characteristics of the mold compounds. For integrated circuit package molding applications, these compounds are typically thermoset compounds that include an epoxy novolac resin or similar material combined with a filler, such as alumina, and other materials to make the compound suitable for molding, such as accelerators, curing agents, filters, and mold release agents.

The transfer molding process as known in the prior art takes advantage of the viscosity characteristics of the molding compound to fill cavity molds containing the die and leadframe assemblies with the mold compound, which then cures around the die and leadframe assemblies to form a hermetic package which is relatively inexpensive and durable, and a good protective package for the integrated circuit.

FIG. 1 depicts a conventional single plunger transfer mold press 11. The press includes a plunger or ram 13 that is operated under hydraulic pressure, a top platen 15, a top mold chase 17, a bottom platen 19, and a bottom mold chase 21. A fixed head 23 supports the plunger and a movable head 18 support the top platen, and allows the top platen to be removed for loading and unloading the mold from the top. Mold heaters 25 provide heat to the mold in both the top and bottom platens. An automated mold controller, although not shown, is usually coupled to the press. The top and bottom platens are usually steel and receive the stresses of the pressing operation; both are heated to provide the temperature needed to perform the transfer molding operation.

FIG. 2 depicts a typical bottom mold chase. In FIG. 2, a top view of bottom mold chase 21 is shown. There are six primary runners 31, each will support a pair of leadframe strips holding wire bonded dies and lead assemblies over each cavity 33. The cavities are formed along the runners 31, which are cylindrical shaped paths that extend from the mold pot 32 and into the rows of cavities. Each cavity is coupled to the runners by a secondary runner 35 which ends in a gate 37, a small opening that lets the mold compound into the cavity. The size and shape of the gate is critical to the speed and control of the transfer and filling stages of the molding process.

FIG. 3 is a detailed drawing of a single runner 31 with a single die cavity 33 shown. The secondary runner 35 is shown coupling the primary runner to the gate 37 and to the die cavity 33. Runner 31 is coupled to the pot 32.

FIG. 4 depicts a cross section BB from FIG. 3. This cross section is taken across the primary runner 31 and along secondary runner 35, and depicts the sloped shape of secondary runner 35 up to the gate 37. The lead frame 51 of a typical bonded part is shown over the bottom mold chase cavity and under the top mold chase cavity 34. Die 53 is shown with the bond wires 55 coupling it to leadframe 51.

The operation of the conventional single pot transfer mold will now be described with reference to FIGS. 2-4. To begin a new molding operation, the mold press is opened and the top and bottom mold chases 17 and 21 are separated. The leadframe and die assemblies are loaded into the bottom mold chases. The mold compound is preheated using an R/F heater or other heater before being placed into the heated mold.

The top and bottom platens are closed, bringing the top and bottom mold chases together. The top and bottom mold chases 17 and 21 are patterned to define a cavity around each die, with the lead frames extending outside the cavity and a space formed around each die. Several leadframe strips each having a row of dies 53, which are bonded to their respective lead frames 51, are placed over the cavities 33 in the bottom mold chase 21. A pellet of resin or similar material mold compound is placed in the mold pot within the top mold chase 17. After an initial heating stage to put the mold compound into its low viscosity state, the plunger or ram 13 is used to begin the transfer phase of the operation. The plunger 13 is brought down through the top mold chase 17 onto the mold compound pellet at a predetermined rate, forcing the mold compound into the primary runners 31. As the runners fill with mold compound the compound will begin filling the secondary runners 35, entering the gates 37 beneath the leadframe and die assemblies 51 and filling the cavities 33.

At the end of the transfer stage the mold compound should fill each cavity 33, preferably at the same time and before the mold compound begins to cure. The rate of the downward force brought by the plunger 13 is varied during the transfer phase to help control the transfer process. Experimental use of the press 11 with a particular mold and compound combination will provide the best combination of pressure and transfer speed which can then be programmed into the automatic press controls to uniformly repeat the process.

After the transfer stage, the packaged parts are cured. Curing the molded parts typically takes 1 to 3 minutes of sitting in the heated mold without disturbance. The compound cure is fairly rapid and may be enhanced by adding curing agents to the compound. At the end of the curing cycle the press is opened and the molded parts and the mold compound sprue or flash in the runners and pot are ejected. This is done by having ejection pins extending through the bottom mold chase 21 and bottom platen 19 push upward under pressure at the same instant, popping the molded parts and sprue out of the bottom mold chase 21. The packaged parts are then removed to other areas where they are separated and trim and form operations performed on the parts.

FIGS. 1-4 depict a transfer mold operation in which each mold cavity is adapted to receive a lead frame 51 having a single die 53 mounted thereon and in which both sides of the lead frame are to be encapsulated with mold compound. In some transfer molding operations only a single side of a leadframe is encapsulated. In such single side encapsulation operations, multiple dies may be mounted on a portion of a lead frame that is positioned within a single cavity formed by a single chase. Such an operation is depicted in FIGS. 5 and 6.

FIGS. 5 and 6 are schematic cross section views of a transfer mold press 78 in a first and second operating state, respectively. The press has a top mold chase 80 that has no cavity therein. The top mold chase 80 has a flat bottom surface 81. A bottom mold chase 82 has a cavity 84 that is adapted to receive a leadframe 90 having a first side 91 and an opposite second side 93, FIG. 5. Multiple dies 100 are mounted on the first side 91 of the leadframe 90. Each die 100 has bond wires 102, 104 electrically connecting it to leadframe 90. A release film 106 is positioned between the second side 91 of the leadframe 90 and the flat bottom surface 81 of the top mold chase 80. The release film 106 is used to facilitate removal of the leadframe 90 from the mold 78 at the end of the molding operation.

A mold pot, shown schematically at 112, is in fluid communication with the bottom mold cavity 84 through a gate 114, FIGS. 5 and 6. The mold pot 112 has a plunger 116 reciprocally mounted therein. Mold compound 120 may be placed in the mold pot, FIG. 5. Plunger 116 may be moved in direction 118, FIG. 5, to cause molten mold compound to flow from the mold pot 112 through gate 114 into cavity 84 as illustrated in FIG. 6. Vents (not shown) in fluid communication with cavity 84 enable air to escape from cavity 84 as the mold compound enters. The mold compound fills cavity 84 encapsulating the dies 100. After the mold compound cools, an encapsulation block 130, thus formed and attached to lead frame 90, is removed from the mold 78 and singulated, i.e. cut into individual, typically rectangular packages, each containing a portion of the lead frame 90 and an attached, epoxy encapsulated die 82.

### BRIEF DESCRIPTION OF THE DRAWINGS

FIG. 1 is a front view of a conventional single plunger mold press;

FIG. 2 is a schematic top view of a bottom mold chase used with the conventional mold press of FIG. 1;

FIG. 3 is a detail view of a portion of the bottom mold chase of FIG. 2;

FIG. 4 is a cross sectional view of the bottom mold chase shown in FIG. 3 and a top mold chase;

FIG. 5 is a schematic cross sectional view of a transfer mold press in a first operating state;

FIG. 6 is a schematic cross sectional view of a transfer mold press in a second operating state;

FIG. 7 is a schematic cross sectional view of a transfer mold press in a first operating state;

FIG. 8 is a schematic cross sectional view of a transfer mold press in a second operating state;

FIG. 9 is a top plan view of a transfer mold lower chase with stacked first and second lead frames positioned over the lower mold cavity;

FIG. 10 is a perspective view of two mechanically joined encapsulation blocks and leadframes;

FIG. 11 is a top plan view of transfer mold lower chase with another embodiment of stacked first and second lead frames positioned over the lower mold cavity;

FIG. 12 is a flow chart of a method of integrated circuit packaging.

### DETAILED DESCRIPTION

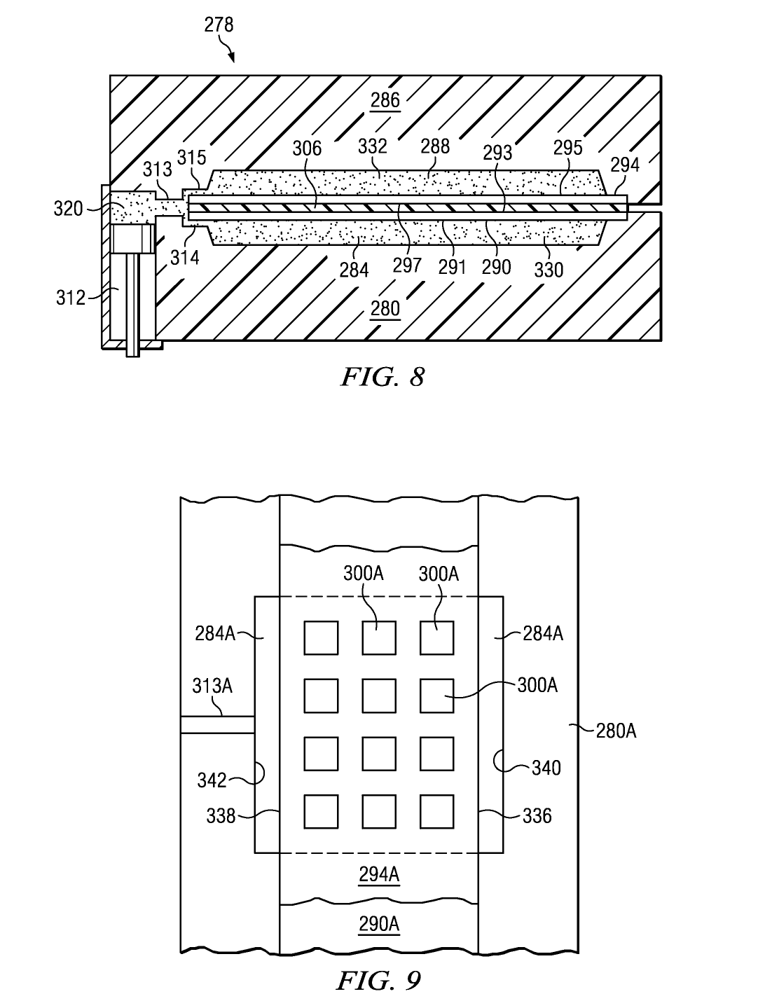

FIGS. 7-12 disclose a transfer mold press 278, the construction and operation of one embodiment of the transfer mold press will now be described generally with reference to FIGS. 7 and 8. The transfer mold press has a bottom mold chase 280 and a top mold chase 286. The bottom mold chase has a bottom mold cavity 284 and the top mold chase has a top mold cavity 288. The bottom and top mold cavities 284, 288 together define the mold cavity of the transfer mold press 278. The bottom mold cavity 284 is adapted to receive a first substrate 290. The first substrate 290 has a first side 291 and an opposite second side 293. At least one first substrate die 300 is mounted on the first substrate first side 291. The top mold cavity 288 is adapted to receive a second substrate 290. The second substrate 290 has a first side 295 and an opposite second side 297. At least one second substrate die 301 is mounted on the top substrate first side 295.

The bottom and top mold chases are constructed and arranged such that the bottom mold cavity 284 is positioned directly opposite the top cavity 288 when the transfer mold press 278 is in a closed position as shown in FIGS. 7 and 8. In this closed position, the first and second substrates 294, 298 are positioned in the bottom and top mold cavities 284, 288, with the second sides 293, 297 of the substrates positioned one below the other in adjacent relationship. Molten mold compound 320 from a mold pot 312 is forced into both the bottom and top mold cavities 284, 288. The mold compound forced into the bottom cavity 284 encapsulates the die(s) 300 mounted on the first substrate 290 forming a first encapsulate block 330. The mold compound forced into the top cavity 288 encapsulates the die(s) 301 mounted on the second substrate 294 forming a second encapsulate block 332. When the chases are separated the two encapsulate blocks are removed and separated. In embodiments where only one die 300 or 301 is mounted on each substrate 290, 294 each encapsulate block forms a single integrated circuit (IC) package, i.e. an encapsulated die/substrate assembly. When multiple dies 300 or 301 are mounted on each substrate, the blocks 330, 332 are singulated into multiple IC packages.

An advantage of this method of IC packaging is that twice as many IC packages can be produce in a single transfer mold press operation as compared to a conventional transfer mold press, without increasing the “footprint” of the transfer mold press. In other words, the output per mold press operating cycle is doubled without increasing the area occupied by the transfer mold press in the horizontal (x,y) plane.

Having thus described an embodiment of a transfer mold press 278 generally, various embodiments of a transfer mold press will now be described in further detail.

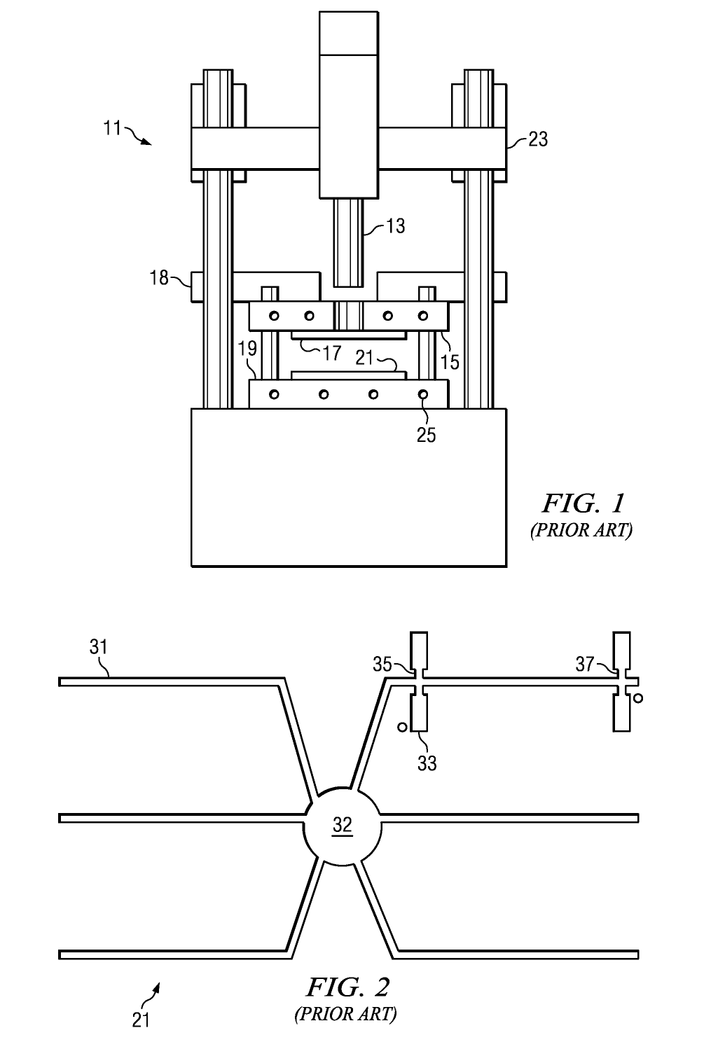

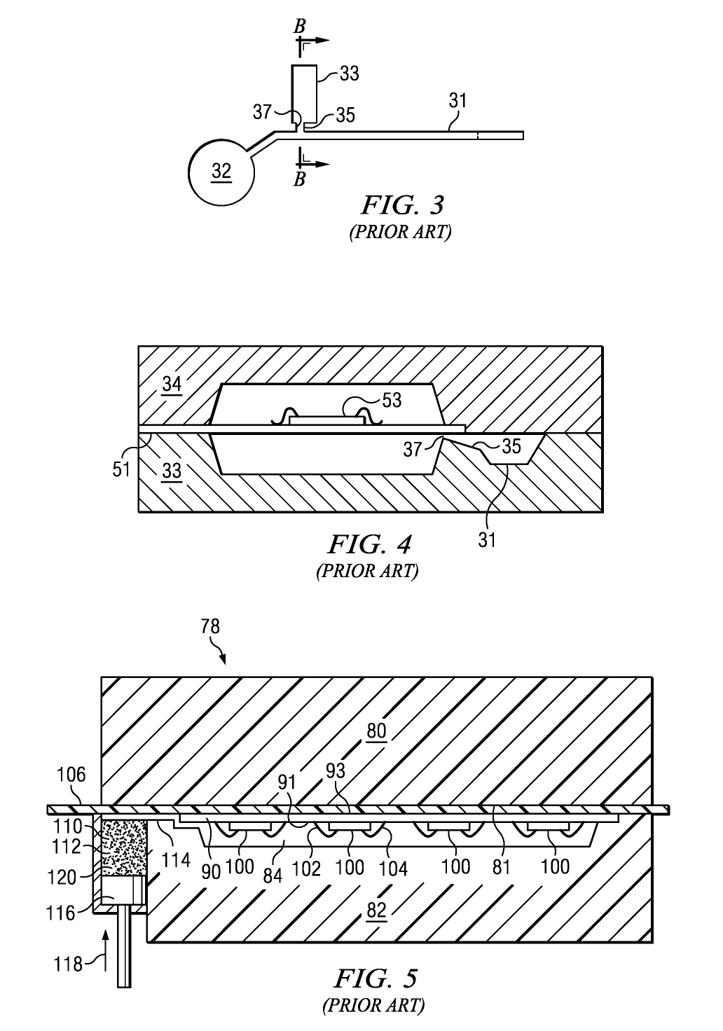

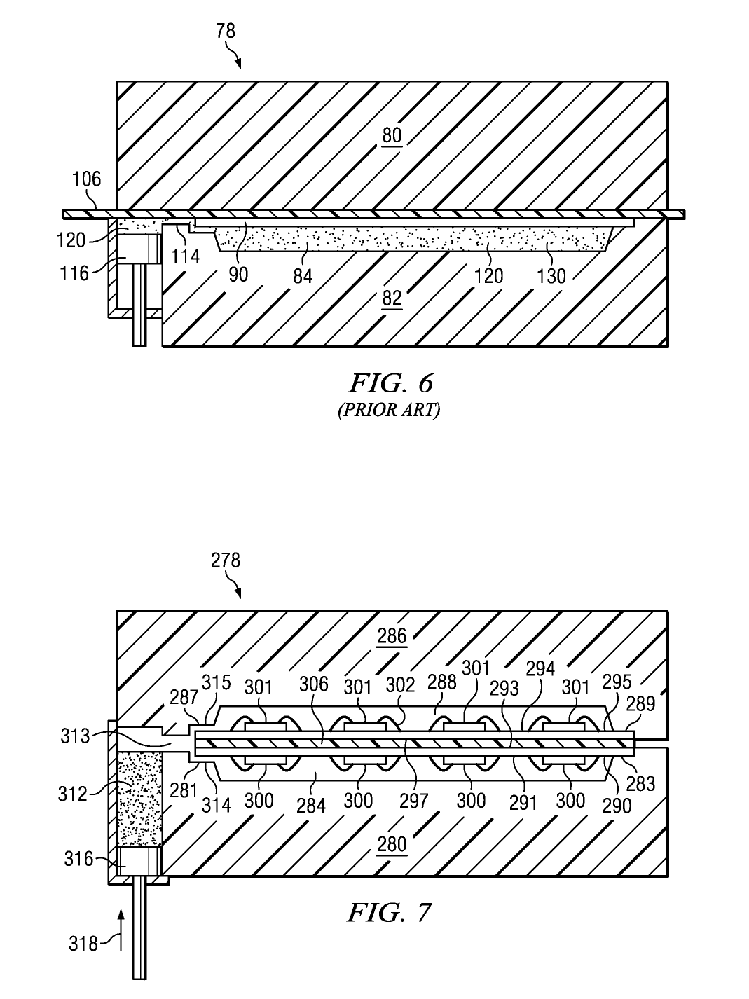

FIGS. 7 and 8 disclose a transfer mold press 278. The press 278 includes a bottom mold chase 280 having a bottom mold cavity 284 and a top mold chase 286 having a top mold cavity 288. The top and bottom mold cavities 284, 288 collectively define a mold cavity. It is to be understood that this mold cavity may be the single mold cavity of the transferable press 278 or it may be one of many cavities such as described for the transfer mold press 78 of FIGS. 1-5. The mold cavity defined by bottom and top mold cavities 284, 288 is adapted to receive and support two substrates therein that are positioned in a stacked relationship. Substrate, as used herein, means an organic or other substrate including a leadframe. The two substrates that are stacked together within the mold cavity include a first substrate 290 and a second substrate 294. The first substrate 290 has a first side 291 and a second side 295. The second substrate 294 has a first side 295 and a second side 297. At least one first substrate die 300 is mounted on the first side 291 of the first substrate and at least one second substrate die 301 is mounted on the first side 295 of the second substrate 294. Each die 300, 301 may comprise one or more bond wires 302 which are electrically connected to the associated substrate. Each substrate 290, 294 has a generally flat plate shape and may support a single die, a single row of dies or multiple rows and columns of dies which would typically be arranged in a rectangular grid. The illustration of FIG. 7 has four dies, 300, 301 visible on each substrate 290, 294, but it may include further columns of dies that are not visible in this cross sectional view.

The substrates 290, 294 are mounted within the mold cavity 284/288 in a stacked relationship in which the first side 291 of the first substrate 290 is positioned adjacent to the first side 295 of the second substrate 294. “Adjacent” or “abutting” as used herein to describe the relationship of first sides 291, 295 means that the two sides 291, 295 are positioned close to one another and may or may not be touching one another. In the embodiment shown in FIG. 7, a release film 306 is positioned between the two substrates 290, 294 and thus the substrates each physically touch the release film 306 without touching the other substrate. In the embodiment shown in FIG. 7, each substrate die assembly 290/300, 294/301 may be identical to the other. In the embodiment illustrated in FIG. 7, the bottom mold chase 280 includes two recessed portions 281, 283 which are positioned at either end of the bottom mold cavity 284. Similarly, the top mold chase 286 may have recessed portions 287, 289. In the embodiment illustrated in FIG. 7, end portions of the first substrate 290 are received and supported in recessed portions 281, 283. In the embodiment illustrated in FIG. 7, the end portions of the second substrate 294 are positioned within the recessed portions 287, 289 when the mold is in the closed operating position. In some embodiments, recessed portions 281, 283 may be made sufficiently deep to receive both substrates 290, 294 in which case recesses 287, 289 are eliminated.

Flow of molten mold compound 320 into the bottom mold cavity 284 and top mold cavity 288 will now be described. The transfer mold press 278 comprises a mold pot 312 which may be a conventional mold pot 312 having a plunger 316 therein which may be moved in direction 318 to move molten mold compound 320 from the mold pot 312 into the bottom and top mold cavities 284, 288. In the embodiment illustrated in FIG. 7, a fluid passageway 313 in fluid communication with the mold pot 312 is connected to lower cavity gate 314 and upper cavity gate 315. Thus, as illustrated in FIG. 8, molten mold compound 320 flows from the mold pot 312 through passageway 313 and lower cavity gate 314 into the bottom mold cavity 284 and through fluid passageway 313 and upper cavity gate 315 into top mold cavity 288. As the molten mold compound 320 enters the mold cavities, there is discharge from the mold cavities through vents (not shown) in the cavities.

When the mold compound cools and solidifies, a first encapsulant block 330 is formed in the bottom mold cavity 284 and a second encapsulant block 332 is formed in the top mold cavity 288. These encapsulant blocks 330, 332 each encapsulate all of the dies located on the first side 291, 295 of each substrate 290, 294. The bottom and top mold chases 280, 286 are then separated and the two encapsulant blocks 330, 332 are then removed from the bottom and top mold cavities and separated. In an embodiment in which a single die 300, 301 are mounted on each of the first and second substrates 290, 294 respectively, each block represents an integrated circuit package including a substrate, 290 or 294, and a die, 300 or 301, mounted thereon and covered with encapsulate. In embodiments in which multiple dies are mounted on each substrate, the encapsulate blocks 330, 332 are singulated into multiple integrated circuit packages.

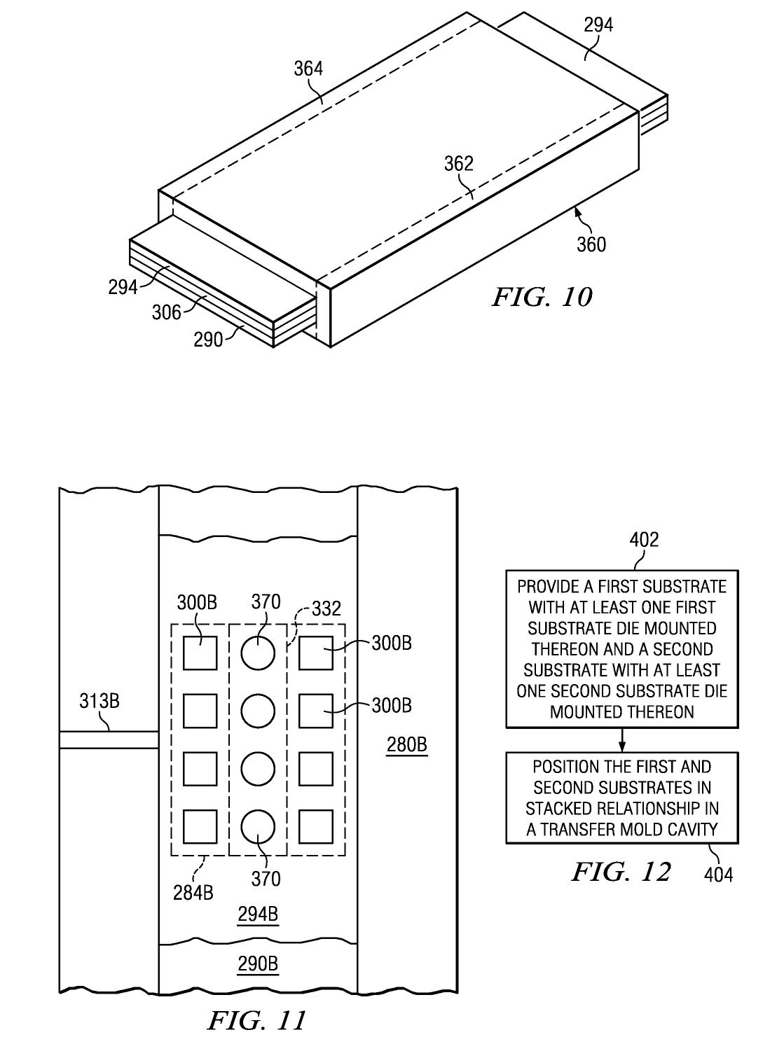

FIG. 9 represents one alternative structure for causing molten mold compound 320 to flow into both the bottom and top mold cavities 284A, 286A (not shown). FIG. 9 is a top plan view of a bottom mold chase 280A having a bottom mold cavity 284A with a rectangular periphery and having a fluid passageway 313A extending from the mold pot (not shown) into the cavity. A pair of stacked substrates 290A, 294A is positioned over the bottom mold cavity 284A. The second substrate 294A is positioned below the first substrate 290A. In this embodiment each substrate 290A, 294A may comprise a portion of a continuous substrate strip which is trimmed into individual substrates after the molding process is completed. In the embodiment of FIG. 9, the second substrate 294A has 12 dies 301A mounted thereon in a three by four grid. In this embodiment, the first and second substrates 290A, 294A each have aligned peripheral edges including aligned lateral side portions 336, 338. These lateral side portions 336, 338 are positioned inwardly of lateral side walls 340, 342 of the bottom mold cavity 284A. In this embodiment, there is no upper cavity gate 315 in the top mold chase (not shown) but fluid flow into the top mold cavity occurs because the molten mold compound 320 flows from the lower mold cavity 284 up into the top mold cavity 288 through the gaps between the lateral side walls 340, 342 of the bottom mold cavity 284A and the lateral side portions 336, 338 of the substrates 290, 294. As a result of this flow around the lateral side portions of the substrates, the two blocks of encapsulant formed in the bottom and top mold cavities 284A, 288A are mechanically joined together at lateral sides portions 362, 364 thereof to form a single encapsulate block 360, as illustrated in FIG. 10. The substrates 290A, 294A and a release film 306A positioned therebetween are visible projecting from the ends of block 360 in FIG. 10. In this embodiment the lateral outside portions 362, 364 must be trimmed from block 360, as with a conventional singulation saw, in order to allow separation of the block 360 into upper and lower blocks. The upper and lower blocks may then each be singulated into 12 integrated circuit packages.

Another structure for enabling flow of molten mold compound 320 into both the bottom and top mold cavities is illustrated in FIG. 11 in which the mold has a bottom mold chase 280B with a bottom mold cavity 284B. A first substrate 290B and second substrate 294B having dies 301 B are positioned over the bottom mold cavity 284B. In this embodiment two columns of dies 301 B are provided on the second substrate 294. In this embodiment both substrates and any intermediate release film that may be positioned therebetween, have circular holes 370 extending therethrough to provide at least one fluid passageway from the bottom mold cavity 284B to the top mold cavity. In this embodiment, as in the embodiment described with respect to FIGS. 9 and 10, the upper and lower encapsulant blocks formed in the upper and lower cavities will be mechanically joined. In this embodiment, such mechanical coupling will be caused by the mold compound that extends through holes 370. Thus in this embodiment, a central portion 332 of the block will need to be trimmed away once the block is removed from the mold cavities. After removal of this section 372, each lateral half of the block will then need to be split into upper and lower blocks and singulated if there is more than one die 301b present. Thus in the embodiment illustrated in FIG. 11, sixteen integrated circuit packages would be provided after the trimming and singulation operation. Although three different techniques for causing mold compound to flow into bottom and top mold cavities, it will be appreciated by those skilled in the art that any single one or any combination of these techniques could be used for this purpose.

FIG. 12 is a flow chart that illustrates a method of integrated circuit packaging. The method includes, as shown in block 400, providing a first substrate having a first side with at least one first substrate die mounted thereon and an opposite second side and a second substrate having a first side with at least one second substrate die mounted thereon and an opposite second side. The method also includes as shown at block 402 positioning the first and second substrates in stacked relationship in a transfer mold cavity.

Although embodiments of certain methods and devices are expressly described herein, it will be obvious to those skilled in the art after reading this disclosure that the methods and devices disclosed herein may be otherwise embodied. The claims attached hereto are to be construed broadly to cover such alternative embodiments, except as limited by the prior art.

What is claimed is:

1. A transfer mold comprising:
a first mold chase having a first chase cavity adapted to receive a first substrate having a first side with at least one first substrate die mounted thereon and an opposite second side; and
a second mold chase having a second chase cavity adapted to receive a second substrate having a first side with at least one second substrate die mounted thereon and an opposite second side;
said second chase cavity being positionable opposite said first chase cavity when said transfer mold is in a closed operating position.

2. The transfer mold of claim 1:
said first and second mold chases being constructed and arranged such that, when said first and second substrates are received therein and said transfer mold is in said closed operating state, said second sides of said first and second substrates are positioned in adjacent relationship.

3. The transfer mold of claim 2 said first and second mold chases being constructed and arranged such that, when said first and second substrates are received therein and said transfer mold is in said closed operating position, said first and second substrates are positioned in mirror image relationship.

4. The transfer mold of claim 1 comprising a mold pot in fluid communication with said first and second mold cavities.

5. The transfer mold of claim 4 comprising a first gate disposed between said mold pot and said first mold cavity.

6. The transfer mold of claim 5 comprising a second gate disposed between said mold pot and said second mold cavity.

7. The transfer mold of claim 3, said first and second substrates being positioned in a substrate stack having a peripheral edge, said first and second cavities each having a cavity periphery, wherein at least a portion of said peripheral edge of said substrate stack is positioned laterally inwardly of said cavity peripheries of said first and second cavities.

8. The transfer mold of claim 3, said first and second substrates being positioned in a substrate stack; said substrate stack having at least one fluid passage extending between said first side of said first substrate and said first side of said second substrate.

9. The transfer mold of claim 3 wherein said first substrate comprises a first lead frame and said second substrate comprises a second lead frame.

10. A method of integrated circuit packaging comprising:
providing a first substrate having a first side with at least one first substrate die mounted thereon and an opposite second side and a second substrate having a first side with at least one second substrate die mounted thereon and an opposite second side;
positioning said first and second substrates in stacked relationship in a transfer mold cavity.

11. The method of claim 10 wherein positioning said first and second substrates in stacked relationship in a transfer mold cavity comprises positioning said second sides of said substrates in adjacent relationship.

12. The method of claim 11 wherein positioning said second sides of said substrates in adjacent relationship comprises positioning said second sides in mirror image adjacent relationship.

13. The method of claim 10 further comprising filing the mold cavity with molten mold compound that encapsulates said at least one first substrate die and said at least one second substrate die.

14. The method of claim 13 wherein said filing the mold cavity with molten mold compound comprises forcing mold compound through a first gate in fluid communication a first portion of the mold cavity.

15. The method of claim 14 wherein said filing the mold cavity with molten mold compound comprises forcing mold compound through a second gate in fluid communication a second portion of the mold cavity.

16. The method of claim 13 wherein said filing the mold cavity with molten mold compound comprises forcing mold compound around edge portions of said first and second substrates.

17. The method of claim 13 wherein said filing the mold cavity with molten mold compound comprises forcing mold compound through at least one hole extending through said first and second substrates.

18. The method of claim 10 wherein said positioning said first and second substrates in stacked relationship in a transfer mold cavity comprises positioning a release film between said substrates.

19. The method of claim 10 wherein said providing a first substrate having a first side with at least one first substrate die mounted thereon and an opposite second side and a second substrate having a first side with at least one second substrate die mounted thereon and an opposite second side comprises providing a first leadframe having a first side with at least one first substrate die mounted thereon and an opposite second side and a second leadframe having a first side with at least one second leadframe die mounted thereon and an opposite second side.

20. A transfer mold assembly comprising:
a first mold chase;
a second mold chase;
a first lead frame;
at least one first lead frame die mounted on said first lead frame;
a second lead frame substantially identical to said first lead frame;
at least one second lead frame die mounted on said second lead frame; and
wherein said first and second mold chases define a transfer mold cavity and wherein said first and second lead frames are positioned in stacked relationship inside said transfer mold cavity.
